(19) United States
(12) Patent Application Publication
(10) Pub. No.: US 2022/0243645 A1
(43) Pub. Date: Aug. 4, 2022

(54) Rotary piston engine having optimized internal cooling of intake air

(71) Applicant: Poul Henrik WOELFLE, Ulm (DE)

(72) Inventor: Paul Andreas WOELFLE, Krefeld (DE)

(21) Appl. No.: 17/312,811

(22) PCT Filed: Dec. 9, 2019
(86) PCT No.: PCT/DE2019/000318

§ 371 Date: Jun. 10, 2021

(30) Foreign Application Priority Data
Dec. 12, 2018 (DE) 10 2018 009 770.7

(51) Int. Cl. F02B 29/04; F01M 11/08; F02B 37/16; F02B 29/02; B01D 45/12

(52) U.S. Cl. CPC F02B 29/0406; F01M 11/08; B01D 45/12; F02B 29/02; F02B 37/16

(57) ABSTRACT

The invention relates to a charged rotary internal combustion engine with intake air internal cooling (EM), characterized in that in the connection between components to be cooled and the inlet into the working area at least one shut-off device (V) is provided, through which charging pressure can escape.

The invention relates to a rotary internal combustion engine. From practice, rotary internal combustion engines are primarily known in epitrochoidal design with a two-lobed epitrochoidal shape of the inner housing surface, as so-called Wankel engines. In such engines, a middle housing with a two-lobed epitrochoidal inner contour—also called trochoid—and housing parts closing the trochoid laterally on each side—also called side plates—form a working area, in which rotates a rotating piston—also called rotor—that has the shape of a triangle with convex sides when seen in a cross-sectional view perpendicular to the center axis of the engine. The rotor drives an eccentric part of a shaft—also called eccentric shaft—on which it is pivot-mounted. The center axis of the eccentric shaft is located on the center axis of the engine in the origin of the trochoid contour. The guidance of the rotor in the working area is usually carried out by an externally toothed stationary gear in a side plate as well as a corresponding internally toothed gear in the rotor.

In multi-rotor designs, several working chambers are arranged side by side. The rotors of the working chambers drive a common, single- or multi-piece eccentric shaft. Side plates between two working chambers that form working areas on either side are also referred to as intermediate plates.

For rotary internal combustion engines, a distinction is made between internal and external cooling. The internal cooling serves for cooling the components within the working area, i.e.—among other parts—rotor(s), eccentric shaft(s) and bearings. The external cooling is primarily used for cooling the housing parts and is not relevant for the invention. Thus, any external cooling can be used on an engine according to the invention.

Internal cooling can be accomplished in different ways. One option is to use the intake air of the engine for internal cooling before it enters the working area. For this purpose, the intake air is first aspirated through an inlet manifold and then guided through a port in one side plate, from where it flows to the eccentric shaft and the inner area of the rotor. The air then flows in parallel with the center axis through the eccentric shaft and rotor and thus reaches the opposite side plate. From there it is guided to the working area of the rotary internal combustion engine through at least one connection, for example, a transfer port that is formed as a recess in the side plate and/or a port, which leads to a circumferential inlet on the trochoid. The invention refers to an engine with such a method of intake air internal cooling.

Rotary internal combustion engines with intake air internal cooling are particularly light and compact. However, with the same size of the working chamber, they have less maximum power than other rotary internal combustion engines. There are several reasons for this.

The main reason is that intake air heats up when it is first used for cooling. This results in lower air density than on an engine, in which non-heated intake air is fed directly into the working area. Another reason is that guiding air through the rotor and eccentric shaft leads to turbulence and rapid volume changes, which affect air flow. In addition, the cooling capacity is limited, because only as much air is available for cooling as can then enter the working area.

In order to improve the volumetric efficiency and consequently increase the maximum power of a rotary internal combustion engines with intake air internal cooling, various optimizations are known. First, the port or ports, which lead the intake air used for cooling into the working area, can be designed in different ways. Also, the intake air used for cooling can be soothed and cooled in an intermediate chamber before it enters the working area. In this way, a charge air cooler can be used, as is disclosed in the document DE2234698A. Another method to increase performance is to provide the engine with an additional inlet, through which non-cooling, cold air can enter directly into the working area, which is particularly suitable for covering short-term power peaks. In addition, it is possible to charge the rotary internal combustion engine, for example by means of a turbocharger or supercharger.

If a rotary internal combustion engine with intake air internal cooling is equipped with a charger, state of the art of throttle control and fuel supply is by means of a carburetor or a throttle body with injection nozzle located at the inlet manifold. In order to prevent pressure peaks on the charger, especially when closing the throttle, a state of the art charge pressure control is used, for example a pressure relief valve in the air passage to the throttle or in case of a turbocharger also a bypass valve in the exhaust gas flow (so-called wastegate).

The disadvantage of the state of the art is that the available air for cooling is directly dependent on the throttle opening, and with fully opened throttle it is limited by the maximum amount of air that can be processed by the engine. As a result, cooling of the engine can be insufficient, especially at full load and fast load changes, which limits the maximum power and durability of the engine.

The invention is based on the exercise to avoid the aforementioned disadvantages and to introduce a rotary internal combustion engine, whose internal components are cooled better, so that higher maximum power and better durability can be achieved.

The exercise is solved by a charged rotary internal combustion engine with intake air internal cooling, whose throttle and pressure relief valve are not located at the inlet manifold, but at the connection to the inlet into the working area.

Then air that escapes through the pressure relief valve can also be used for internal cooling. As a result, the air available for cooling is no longer limited by the throttle position or the amount of air that can be processed by the engine, and the charger can be designed to suit the cooling requirement of the engine.

In addition, it is possible to use a charger which is over-dimensioned in relation to the maximum amount of air that can be processed by the engine. When using a turbocharger, this is also advantageous for the charger itself, because rotary internal combustion engines tend to have high exhaust gas temperatures, which impose stress on a charger, and a charger that is larger in relation to the engine offers more surface for cooling and can process more cooling intake air.

As with conventional charged engines, a charge air cooler between the charger and inlet manifold can be used with a rotary internal combustion engine according to the invention.

In addition, with an engine according to the invention, it is possible to implement a possibly additional charge air cooler in the connection between the area to be cooled and the inlet into the working area in order to cool the air flowing into the working area, which was previously used for cooling. Pressure relief valve and throttle can then be located upstream or downstream of the charge air cooler, whichever is more useful for the installation and/or operation of the rotary internal combustion engine.

Air escaping from the pressure relief valve may be heated from the use for internal cooling, but it is significantly cooler than some components of the engine, especially those in the area of the outlet. Hence it is possible according to the invention to direct air escaping through the pressure relief valve to further components in order to cool them, for example to the exhaust system and/or to the turbine side of a turbocharger. The air can be blown onto the outside of the components, and if the components are in an enclosure, the enclosure can also be used to capture oil that escapes through the pressure relief valve. Also, according to the invention, it is possible to introduce air from the pressure relief valve into the exhaust gas flow and thus lower the exhaust gas temperature. Air escaping through the pressure relief valve can also be directed to the inlet side of the charger in order to reduce the required suction power.

The pressure relief valve itself may correspond to any known state of the art. The previously chosen term of a pressure relief valve serves only to illustrate the function. In fact, according to the invention, any shut-off device can be used. It is possible, for example, to use a valve loaded with a spring or to use a flap that is adjusted by a vacuum actuator. It is also possible according to the invention to use an electronically controlled shut-off device. Such a device can then not only be operated depending on one pressure sensor or possibly also several pressure sensors located in different areas, but it can also be operated depending on other parameters such as at least one throttle position or change, temperatures in the engine and/or the power requirement of the engine.

On multi-rotor rotary internal combustion engines according to the invention, direction of the air flow can be carried out in different ways. Thus, the working areas can be sealed to each other at the eccentric shaft, so the supplied air is first distributed to the working areas via a manifold, and then the internal components of the working areas are cooled separately. Connections to the inlets into the working areas can then be provided with separate throttles and shut-off devices. It is also possible, according to the invention, to merge the air used for cooling in an intermediate chamber or a charge air cooler, at which then only one throttle and shut-off device is provided, and afterwards to distribute the air to the inlets into the working areas with a manifold.

According to the invention, it is also possible with multi-rotor (and particularly sensible with dual-rotor) rotary internal combustion engines to direct cooling air from a charger into the outer side plates and to refrain from sealing of the working areas at the eccentric shaft, so the air is merged in a common port in at least one intermediate plate before it is led to the intakes as described above. Conversely, it is also possible to direct cooling air centrally into at least one intermediate plate, which then enters the working areas via the side plates (or further intermediate plates) as well as previously described separate or merged connections to the intakes into the working areas.

In addition, on multi-rotor rotary internal combustion engines, it is possible according to the invention to direct cooling air into one side plate and let it flow through the internal components and intermediate plates of several or all working areas. If cooling air flows all the way to the opposite side plate, again a single throttle and shut-off device in the connection to the intakes are sufficient. However, several throttles and/or shut-off devices can also be used, provided this is advantageous for the operation of the engine. In addition, any combination of the aforementioned air ducts for multi-rotor rotary internal combustion engines according to the invention is possible.

On conventional rotary internal combustion engines with intake air internal cooling, oil required for lubrication of internal components is either pre-mixed with fuel or supplied separately using an oil pump. In any case, fuel supply is via a carburetor or throttle body at the inlet manifold. Both fuel and oil mix with the intake air used for internal cooling and so get directed to the inlet of the working area. Consequently, there is no re-circulation of oil, and it is completely combusted instead.

In contrast to this, on rotary internal combustion engines with intake air internal cooling according to the invention, it is provided to supply oil separate from fuel. It is further provided according to the invention that oil can be separated at least partially from air used for cooling after passing through the components to be cooled and before entering the working area using a state of the art separator. Also, a potentially additional separator may be used at the outlet of the shut-off device, so that no oil escapes in this way. Depending on the position and design of a charge air cooler, it can also act as a separator, for example by appropriate design and/or by having oil condense inside the charge air cooler and leading it out of the charge air cooler separately. If air escaping through the shut-off device is directed to the inlet of the compressor side of the charger, the charger can also be used as a separator using the centrifugal forces occurring, and it is then also possible to abstain from using a separator, because oil will be directed back to the internal components anyway.

By using an oil separator, the amount of oil can be increased, and at the same time the oil consumption can be reduced. In order to prevent, in particular, that fuel also enters the separator when using liquid fuel, it is also provided according to the invention to supply liquid fuel only after oil has been separated from the intake air or directly into the working area. When using gaseous fuel, however, it may be sufficient to feed it into the air flow downstream from a shut-off device according to the invention.

The use of an oil separator and supply of liquid fuel downstream from a separator is possible according to the invention not only for a previously described charged rotary internal combustion engine with intake air internal cooling, but also for conventional rotary internal combustion engine with intake air internal cooling.

If the remaining amount of oil entering the working area should be insufficient to lubricate the sealing elements of the rotor in the working area, it is provided according to the invention to feed oil to the sealing elements separately.

The term air or intake air is used in the description. It is understandable that instead of air, another medium suitable for operating an engine can be used. It is also understandable that an engine according to the invention can be provided with any other optimizations according to the state of the art. For example, a multi-stage charger, a charger with electrical support or an additional use of the exhaust energy (so-called turbo compound) can be applied.

In the following, embodiments of the invention presented are shown with reference to the accompanying drawings.

In all figures, matching reference characters are used for identical or similar parts.

It is understandable that the shown components and contours are only exemplary, so any combination and embodiment is possible.

Shown are in:

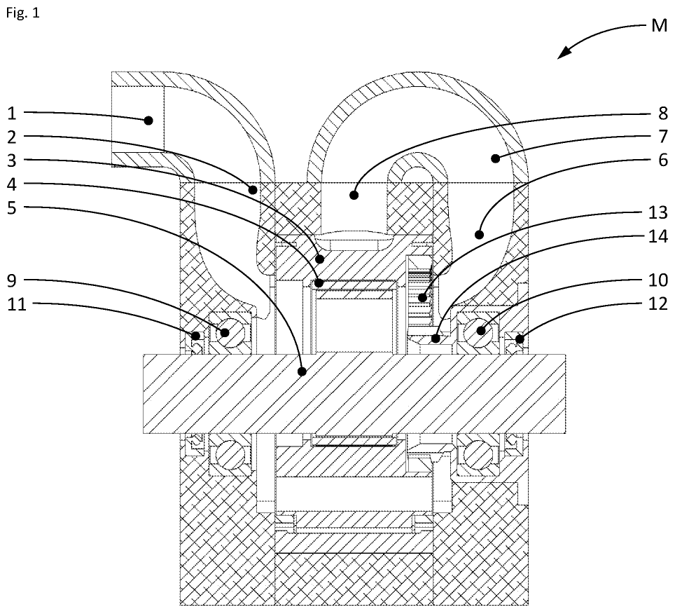

FIG. 1 a rotary internal combustion engine with intake air internal cooling according to the state of the art in sectional view to explain the components.

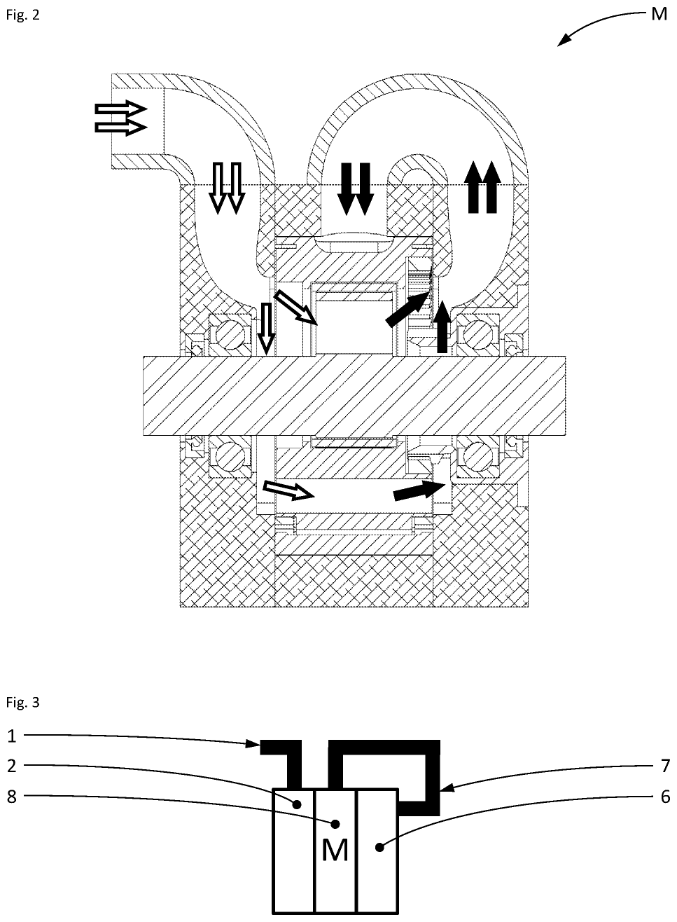

FIG. 2 the rotary internal combustion engine from FIG. 1 for illustration of air flow.

FIG. 3 a rotary internal combustion engine with intake air internal cooling according to the state of the art as a schematic diagram.

FIG. 4 as a schematic diagram a charged rotary internal combustion engine with intake air internal cooling according to the state of the art.

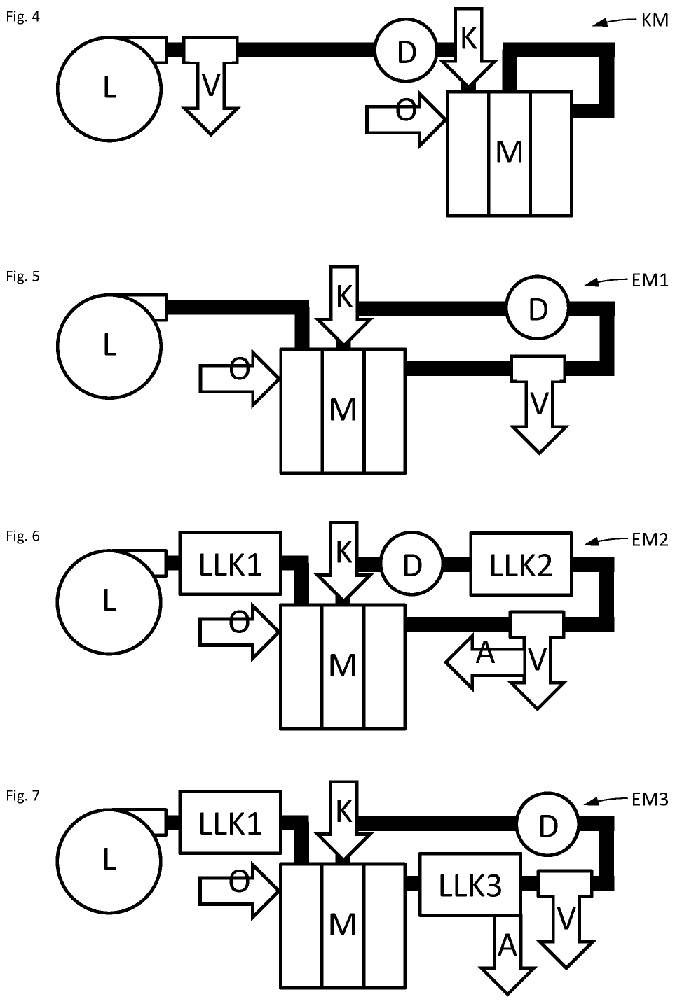

FIG. 5-9 as schematic diagrams charged rotary internal combustion engines according to the invention with intake air internal cooling.

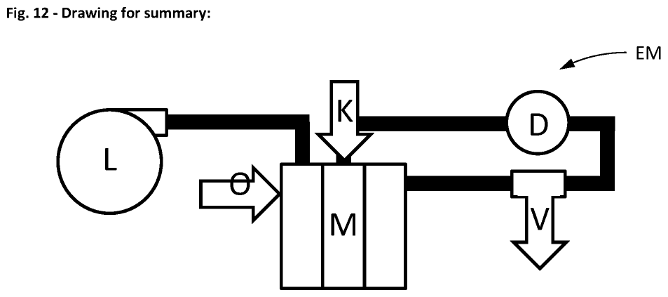

FIG. 10-11 as schematic diagrams how air escaping from the shut-off device of an engine according to the invention can be used for cooling hot engine components.

FIG. 1 serves to explain the components and shows a rotary internal combustion engine in epitrochoidal design and with intake air internal cooling (M) in sectional view through the center axis and the inlet port. Shown is the inlet manifold (1), the side plate connected with the inlet manifold (2), the rotor (3), the eccentric shaft (5), the so-called main bearing (4) between rotor (3) and eccentric shaft (5), the second side plate (6), the trochoid (8) as well as a bridge (7) which serves as a connection between the side plate (6) and trochoid (8). Further shown to offer an overview are lateral bearings (9, 10) of the eccentric shaft (5), shaft seals (11, 12) to seal the eccentric shaft (5), as well as the gear (13) in the rotor (3) and the corresponding stationary gear (14) in the side plate (6).

FIG. 2 shows with arrows on the basis of the sectional view from FIG. 1 how inlet air flows through a rotary internal combustion engine in epitrochoidal design and with intake air internal cooling (M). White arrows indicate cold air, black arrows indicate heated air. Cold air first enters the inlet manifold (1) and flows from there through the side plate (2). When exiting from the side plate (2), the air disperses to the rotating components, rotor (3), main bearing (4) and eccentric shaft (5). The air flow passes and cools rotor (3), main bearing (4) and eccentric shaft (5) and thus heats up. In the side plate (6) the air accumulates again, and via a connection, in this case formed as a bridge (7), it enters the inlet area of the trochoid (8).

FIG. 3 shows a previously described rotary internal combustion engine in epitrochoidal design and with intake air internal cooling (M) as a schematic diagram. Indicated are the two side plates, the trochoid, as well as the inlet manifold and the connection from the side plate to the inlet area of the trochoid.

FIG. 4 schematically shows a charged rotary internal combustion engine in epitrochoidal design and with intake air internal cooling (KM) according to the state of the art. Here, a charger (L)—for example, a supercharger or turbocharger—is connected with the inlet manifold and generates charging pressure, and a charge pressure control according to the state of the art is used. Shown is a shut-off device designed a pressure relief valve (V) upstream from the throttle. In turbochargers the charging pressure can alternatively or supplementary be controlled by a bypass valve in the exhaust gas flow (so-called wastegate). Air conveyed by the charger (L) and not escaped through the pressure relief valve (V), possibly after passing through a charge air cooler not shown here, gets to a throttle (D), which is designed as a carburetor or throttle body with a nozzle for injection of fuel (K). The oil supply (O) is carried out separately in the illustrated example, but could also be done by mixing oil with the fuel.

FIG. 5 schematically shows a charged rotary internal combustion engine in epitrochoidal design and with intake air internal cooling according to the invention (EM1). Again, the charger (L)—for example a supercharger or turbocharger—is connected to the inlet manifold and generates charging pressure. However, shut-off device (V) and throttle (D) are now located downstream of the engine (M), so the total amount of air conveyed by the charger flows through the engine (M). To lubricate the internal components of the engine (M), a separate oil supply (O) is required. The fuel supply (K) can be implemented as before, i.e. in the throttle (D) or downstream from the throttle (D).

FIG. 6 again schematically shows a charged rotary internal combustion engine in epitrochoidal design and with intake air internal cooling according to the invention (EM2). In this embodiment a charge air cooler (LLK1) is provided between the charger (L) and the engine (M) in order to cool the air that has possibly been heated by the charger (L) and thus also to better cool the engine (M). A second charge air cooler (LLK2) is provided between the shut-off device (V) and the throttle (D) to cool air heated by cooling the engine (M) before entering into the working area of the engine (M). The shut-off device (V) is also equipped with an oil separator (A), so oil can be separated from air escaping through the shut-off device (V) and used again for lubrication. The oil separator (A) could also be provided separately from the shut-off device (V) in the area between the engine (M) and the shut-off device (V) or in addition in the area between the engine (M) and fuel supply (K). This is also possible with an engine with intake air internal cooling (M) without charging.

FIG. 7 shows schematically as a further option a charged rotary internal combustion engine in epitrochoidal design and with intake air internal cooling according to the invention (EM3) analogous to FIG. 6, wherein the charge air cooler (LLK3) downstream of the engine (M) also acts as an oil separator (A). This is also possible according to the invention with an engine with intake air internal cooling (M) without charging.

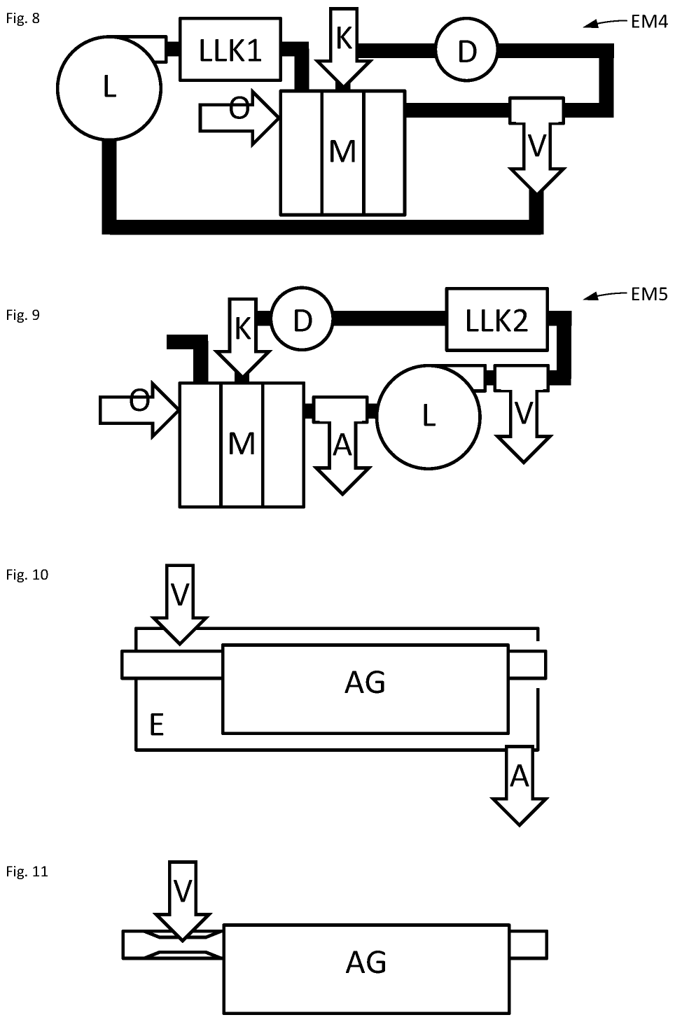

FIG. 8 schematically shows as a further embodiment a charged rotary internal combustion engine in epitrochoidal design and with intake air internal cooling according to the invention (EM4) analogous to FIG. 5. In this case air escaping through the shut-off device (V) is led to the inlet of the compressor side of the charger (L) to reduce the required suction power. If centrifugal forces occur in the charger, it can also be used as an oil separator. It is also possible to abstain from using a separator, because oil will be directed back to the internal engine components anyway. Due to the temperature of the recirculated air, a charge air cooler (LLK1) is sensible in this example.

FIG. 9 schematically shows another variant of a charged rotary internal combustion engine in epitrochoidal design and with intake air internal cooling according to the invention (EM5). Here the charger (L) is also provided downstream of the engine (M) and sucks air through the inlet manifold of the engine (M). As before, a separate oil supply is provided, and the oil separator (A) is upstream of the charger (L) in the direction of air flow. Downstream of the charger (L), the shut-off device (V), a charge air cooler (LLK2), the throttle (D) and the fuel supply (K) follow as before.

FIG. 10 schematically shows the connection of a shut-off device (V) of a charged rotary internal combustion engine in epitrochoidal design and with intake air internal cooling according to the invention (EM1-5) with an enclosure (E) in which an exhaust system (AG) with exhaust manifold, silencer and outlet is located. Air escaping through the shut-off device (V) flows through the enclosure (E) and cools the exhaust system (AG) inside the enclosure, which can facilitate its integration, durability and choice of materials. In the example shown, the air escapes through an opening where the exhaust system is located. On the enclosure an oil separator (A) is also provided, with which oil that escapes through the shut-off device (V) can be collected and returned to the oil circuit. It makes sense to direct oil-containing air flow to the oil separator (A) in such a way that no oil is fed to components on which it can evaporate or even ignite.

It is understandable that in practice there could be interconnections and ports between the shut-off device (V), enclosure (E), exhaust system (AG) and oil separator (A), which are not shown here for better clarity. It is also understandable that when using a turbocharger as a charger (L), the hot turbine side of the charger (L) can be accommodated within the enclosure (E).

FIG. 11 schematically shows the connection of a shut-off device (V) of a charged rotary internal combustion engine in epitrochoidal design and with intake air internal cooling according to the invention (EM1-5) with the manifold of an exhaust system (AG). In order to facilitate the discharge of air escaping from the shut-off device (V) into the exhaust manifold, a venturi nozzle is provided in the example shown. By mixing the discharged air with the exhaust gas flow, the temperature of the exhaust gases is reduced, which can facilitate the integration and choice of materials of the exhaust system (AG).

1. Rotary internal combustion engine with intake air internal cooling (M), characterized in that in at least one connection between components to be cooled (3, 4, 5) and at least one inlet into the working area at least one oil separator (A) is provided.

2. Rotary internal combustion engine with intake air internal cooling (M) according to the preceding claim, characterized in that in at least one connection between components to be cooled (3, 4, 5) and at least one inlet into the working area at least one charge air cooler (LLK2) is provided.

3. Rotary internal combustion engine with intake air internal cooling (M) according to the preceding claim, characterized in that at least one charge air cooler (LLK3) is combined with an oil separator (A).

4. Charged rotary internal combustion engine with intake air internal cooling (EM1-5), characterized in that in at least one connection between components to be cooled (3, 4, 5) and at least one inlet into a working area at least one shut-off device (V) is provided, through which charging pressure can escape.

5. Rotary internal combustion engine (EM1-5) according to the previous claim and at least one of claims 1-3.

6. Rotary internal combustion engine (EM2) according to claim 4 or 5, characterized in that at least one oil separator (A) is provided in at least one shut-off device (V) or at least one connection adjacent to the shut-off device (V).

7. Rotary internal combustion engine (EM4) according to any of the claims 4-6, characterized in that air escaping from at least one shut-off device (V) is led to the inlet of the compressor side of the charger (L).

8. Rotary internal combustion engine (EM1-5) according to any of the claims 4-7, characterized in that air escaping from at least one shut-off device (V) is led into at least one enclosure (E), in which at least parts of the exhaust system (AG) of the rotary internal combustion engine (EM1-5) are located and at least one turbine side of a turbocharger (L) can be located as well.

9. Rotary internal combustion engine (EM1-5) according to the preceding claim, characterized in that at least one enclosure (E) is provided with at least one oil separator (A).

10. Rotary internal combustion engine (EM1-5) according to any one of the claims 4-9, characterized in that air escaping from at least shut-off device (V) is fed into at least one exhaust system (AG) of the rotary internal combustion engine (EM1-5).
